(19) United States
(12) Patent Application Publication
(10) Pub. No.: US 2006/0057435 A1
(43) Pub. Date: Mar. 16, 2006

(54) Method and apparatus for preventing fuel decomposition in a direct liquid fuel cell

(75) Inventors: Gennadi Finkelshtain, Shoham (IL); Yuri Katsman, Hadera (IL); Ilan Sadon, Kefar Uria (IL); Mark Estrin, Meuhad (IL); Alexander Litvinov, Netanya (IL); Boris Ilyushin, Novosibirsk (RU); Alexander Chinak, Novosibirsk (RU)

Correspondence Address: GREENBLUM & BERNSTEIN, P.L.C., 1950 ROLAND CLARKE PLACE, RESTON, VA, 20191, US

(73) Assignee: Medis Technologies Ltd, Yehud (IL)

(21) Appl. No.: 10/941,020

(22) Filed: Sep. 15, 2004

(51) Int. Cl. H01M 8/00

(52) U.S. Cl. 429/12; 429/13

(57) ABSTRACT

A fuel cell includes a cathode, an anode, a fuel chamber, and a membrane arranged between the anode and the fuel chamber. The membrane is structured and arranged to allow gas to accumulate adjacent the anode at least to a point where the gas limits or substantially prevents a contact between the anode and a fuel. The method includes generating electrical energy with the fuel cell, preventing further generation of electrical energy of the fuel cell, and facilitating, with the membrane, an accumulation of the gas adjacent the anode at least to a point where the gas substantially prevents a contact between the anode and the fuel. Another method includes using a gas which is formed by an initial decomposition of the fuel to restrict or substantially prevent any further contact between the fuel and the anode. This Abstract is not intended to define the invention disclosed in the specification, nor intended to limit the scope of the invention in any way.

### BACKGROUND OF THE INVENTION

1. Field of the Invention

The present invention relates to a Direct Liquid Fuel Cell (DLFC) which uses a hydride fuel and also relates to specifically preventing or at least substantially reducing the generation of hydrogen caused by a decomposition of the hydride fuel at the anode of the fuel cell when the DLFC is under no or only a low load.

A hydride fuel decomposition reaction at the anode of the fuel cell generates hydrogen during the period where the fuel cell is under no or only a low load. The invention thus also provides a method which uses this hydrogen to provide a separation layer between the anode and the liquid fuel. In this way, the fuel is substantially prevented from contacting the anode, whereby decomposition of the fuel is prevented to at least a substantial extent.

One way in which this can be accomplished is by arranging a special membrane close to that surface of the anode which faces the fuel chamber. The initially generated hydrogen accumulates between the membrane and the anode, and pushes or forces out the liquid fuel from the space between the anode and the membrane. This causes the liquid fuel to separate from the anode.

2. Discussion of Background Information

The most commonly used liquid fuel for a DLFC is methanol. The main disadvantages of such Direct Methanol Fuel Cells (DMFCs) are the toxicity of methanol and the very poor discharge characteristics at room temperature. As a result, DMFCs are not generally used for portable electronics applications and the like.

Fuels based on (metal) hydride and borohydride compounds such as, e.g., sodium borohydride have a very high chemical and electrochemical activity. Consequently, DLFCs which use such fuels have extremely high discharge characteristics (current density, specific energy, etc.) even at room temperature.

For example, the electro-oxidation of borohydride fuels on the anode surface of a fuel cell occurs in accordance with the following equation:
BH₄⁻+8OH⁻=BO₂⁻+6H₂O+8e⁻ (1)

The main problem associated with hydride and borohydride fuels is a spontaneous decomposition of the fuel on the (active layer of the) anode surface which is accompanied by a generation of hydrogen, usually in the form of microbubbles, e.g., bubbles of from about 0.01 to about 2 mm in size. This process is particularly significant in a DLFC open circuit regime and in a stand-by (low current) regime.

The decomposition of a borohydride compound occurs according to the following equation:
BH₄⁻+2H₂O→BO₂⁻+4H₂↑(2)

Hydride and borohydride decomposition at the anode of a DLFC results in several technical problems, in particular, energy loss, destruction of the anode active layer, and decreasing safety characteristics. As a result, there is a need to develop ways to substantially prevent the fuel from decomposing while the DLFC is under no or no substantial load.

### SUMMARY OF THE INVENTION

The present invention provides a liquid fuel cell for use with a liquid fuel that is prone to undergo decomposition on the surface of the anode and generates gas in the course of this decomposition. The fuel cell comprises a cathode, an anode, an electrolyte chamber which is arranged between the cathode and the anode, a fuel chamber which is arranged on that side of the anode which is opposite to the side which faces the electrolyte chamber, and a membrane which is arranged on that side of the anode which faces the fuel chamber. The membrane is structured and arranged to allow gas which is formed on or in the vicinity of the surface of the anode that faces the fuel chamber to accumulate adjacent the anode at least to a point where the gas substantially prevents a direct contact between the anode and the liquid fuel when liquid fuel is present in the fuel chamber.

According to one aspect of the invention, the fuel of the fuel cell may comprise a metal hydride and/or borohydride compound and the gas may comprise hydrogen.

In another aspect, the membrane may comprise a single layer of material and/or the membrane may comprise a layer of hydrophilic material. The hydrophilic material may comprise a metal and/or a metal alloy. By way of non-limiting example, the hydrophilic material may comprise stainless steel.

In yet another aspect of the fuel cell, the membrane may comprise a mesh, for example, a stainless steel micromesh. In another aspect, the micromesh may comprise cells which have a size of up to about 0.5 mm, e.g., of from about 0.06 μm to about 0.05 mm. In a still further aspect, the membrane (mesh) may have a thickness of from about 0.03 mm to about 0.3 mm.

In another aspect of the fuel cell of the present invention, the fuel cell may further comprise a spacer material which is arranged between the membrane and the anode. The spacer material may comprise a single layer of material and/or it may comprise a hydrophobic material such as, e.g., a layer of hydrophobic material. The hydrophobic material may comprise a polymeric material. By way of non-limiting example, the hydrophobic material may comprise an olefin homopolymer and/or an olefin copolymer, e.g., one or more of polyethylene, polypropylene and polytetrafluoroethylene.

In a still further aspect, the spacer material may comprises a net, for example, a wattled net. In another aspect, the net may comprise openings of from, e.g., about 1 mm to about 50 mm.

In another aspect, the spacer material may have a thickness of up to about 3 mm, preferably up to about 1.5 mm and/or may have a thickness of at least about 0.1 mm, preferably at least about 0.5 mm.

In yet another aspect of the fuel cell of the present invention, the fuel cell may further comprise a frame seal which is arranged on that surface of the anode which faces the membrane. The frame seal may comprise a single layer of material and/or may comprise a hydrophobic material, e.g., in the form of a layer of hydrophobic material. The hydrophobic material may comprise an olefinic polymer, for example, a fluorinated polymer. In particular, the hydrophobic material may comprise polytetrafluoroethylene. In another aspect, the frame seal may have a thickness of up to about 0.1 mm, e.g., of from about 0.02 mm to about 0.05 mm.

In a still further aspect, the fuel cell of the present invention may comprise a pressure relief device. This device is arranged to allow the gas to escape from a space between the anode and the membrane, e.g., into the fuel chamber. The pressure relief device may comprise a small diameter tube, for example a tube having an inner diameter of up to about 2 mm, preferably, of up to about 1 mm. The small diameter tube may have a length of up to about 20 mm, for example, up to about 10 mm. In one embodiment, the small diameter tube may comprise a capillary needle and/or a stainless steel tube, e.g., a tube having a length of about 7 mm and an inside diameter of about 1 mm.

In yet another aspect of the fuel cell of the present invention, the membrane and the anode may be arranged substantially in parallel. In a further aspect, the membrane and the spacer material may form an integral structure.

The present invention also provides a direct liquid fuel cell for use with a liquid fuel that is prone to undergo decomposition with generation of a gas. This fuel cell comprises a cathode, an anode, an electrolyte chamber arranged between the cathode and the anode, a fuel chamber arranged on that side of the anode which is opposite to the side which faces the electrolyte chamber, a membrane arranged on that side of the anode which faces the fuel chamber, and a spacer material which has a thickness of at least about 0.1 mm and is arranged between the anode and the membrane. The membrane and the spacer material are structured and arranged to allow gas which is formed on or in the vicinity of the surface of the anode which faces the fuel chamber to accumulate adjacent the anode at least to a point where the gas substantially prevents a direct contact between the anode and the liquid fuel when the fuel chamber contains liquid fuel.

In one aspect of this fuel cell, the membrane may comprise a hydrophilic material such as, e.g., a metal or a metal alloy. Further, the membrane may comprise a mesh such as, e.g., a stainless steel micromesh. The micromesh may comprise cells having a size of up to about 0.5 mm, e.g., of up to about 0.06 mm.

In another aspect of the fuel cell, the spacer material may comprise a hydrophobic material such as, e.g., an olefin homopolymer and/or an olefin copolymer. For example, the spacer material may comprise polypropylene. Also, the spacer material may comprise a wattled net. For example, the wattled net may comprise cells which have dimensions of from about 2 mm to about 3 mm. In another aspect, the spacer material may have a thickness of up to about 0.5 mm.

In yet another aspect of the above fuel cell, the fuel cell may further comprise a frame seal which is arranged on the surface of the anode which faces the membrane. The frame seal may comprise a hydrophobic material such as, e.g., a fluorinated polymer. For example, the frame seal may comprise polytetrafluoroethylene. In one aspect, the frame seal may have a thickness of up to about 0.1 mm.

According to another aspect of the fuel cell, the fuel cell may further comprise a pressure relief device which is arranged to allow the gas to escape from a space between the anode and the membrane, e.g., into the fuel chamber. The pressure relief device may comprise a tube having an inner diameter of up to about 1 mm and/or a length of up to about 20 mm. For example, the pressure relief device may comprise a capillary needle and/or a stainless steel tube.

The present invention further provides a direct liquid fuel cell for use with a liquid fuel that is prone to undergo decomposition with generation of a gas. The fuel cell comprises a cathode, an anode, an electrolyte chamber arranged between the cathode and the anode, a fuel chamber which is arranged on that side of the anode which is opposite to the side which faces the electrolyte chamber, a membrane which is arranged on that side of the anode which faces the fuel chamber, a spacer material which is arranged between the anode and the membrane, and a pressure relief device for allowing gas which is present between the anode and the membrane to escape into the fuel chamber. The membrane, the spacer material and the pressure relief device are structured and arranged to allow gas which is formed on or in the vicinity of that surface of the anode which faces the fuel chamber to accumulate adjacent the anode at least to a point where the gas substantially prevents a direct contact between the anode and the liquid fuel when liquid fuel is present in the fuel chamber.

In one aspect of the fuel cell, the membrane may comprise a hydrophilic material such as, e.g. a metal or a metal alloy. In another aspect, the membrane may comprise a micromesh such as, e.g., a stainless steel micromesh. The micromesh may comprise cells having a size of up to about 0.5 mm.

In another aspect of the fuel cell, the spacer material may comprise a hydrophobic material, for example, a polymeric material. A non-limiting example of the polymeric material is polypropylene. Further, the spacer material may comprise a net. The net may comprise openings of up to about 50 mm. In another aspect, the spacer material may have a thickness of up to about 1.5 mm and/or at least about 0.5 mm.

In another aspect, the fuel cell may further comprise a frame seal which is arranged on that surface of the anode which faces the membrane. The frame seal may comprise a hydrophobic material such as, e.g., polytetrafluoroethylene. In another aspect, the frame seal may have a thickness of up to about 0.05 mm.

The present invention also provides a method of reducing or substantially preventing a fuel decomposition at the anode of a direct liquid fuel cell which uses a fuel that generates a gas when undergoing said decomposition. This method comprises using the gas which is formed by the initial decomposition of the fuel to limit or substantially prevent any further contact between the fuel and the anode.

In a preferred aspect of this method, the gas may substantially prevent the fuel from further contacting the anode. In another aspect, the initially generated gas may be caused to form a substantially continuous layer of gas across substantially the entire surface of the anode that faces the fuel chamber of the fuel cell.

In another aspect of the method, the fuel may comprise a hydride and/or a borohydride compound, for example, an alkali metal borohydride. By way of non-limiting example, the fuel may comprise sodium borohydride dissolved or suspended in a liquid vehicle or carrier such as, e.g., methanol and/or water. Further, the gas preferably comprises hydrogen.

In another aspect of the method, the flow of the initially generated gas away from the anode may be restricted or substantially prevented.

In a further aspect, the fuel decomposition may occur as a result of placing the fuel cell under substantially no load.

In yet another aspect, the initial fuel decomposition may be substantially stopped within not more than about 5 minutes, e.g., within not more than about 3 minutes.

In a still further aspect of the method of the present invention, the method may comprise arranging a structure which restricts or substantially prevents the ability of the gas to flow away from the anode on that side of the anode which faces the fuel chamber. This structure may comprise a membrane and a spacer material for providing a space between the anode and the membrane, this space being capable of being substantially filled with the gas.

The present invention also provides a method of preventing or reducing fuel decomposition in a fuel cell of the present invention. This method comprises the generation of electrical energy with the fuel cell; substantially preventing the fuel cell from further generating electrical energy; and facilitating, with the membrane, an accumulation adjacent the anode of the gas generated at the anode at least to a point where the gas limits or substantially prevents a contact between the anode and the fuel.

The present invention also provides a another method of preventing or reducing fuel decomposition in a fuel cell of the present invention. This method comprises the generation of electrical energy with the fuel cell; substantially preventing the fuel cell from further generating electrical energy; and causing the gas generated at the anode to accumulate adjacent the anode at least to a point where the gas substantially prevents a contact between the anode and the fuel.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross section view of a prior art fuel cell;

FIG. 2 shows cross section of a fuel cell according to the invention;

FIG. 3 shows an enlarged portion of FIG. 2;

FIG. 4 presents a chart illustrating hydrogen productivity in a fuel cell of the type shown in FIG. 1;

FIG. 5 presents a chart illustrating hydrogen productivity in a fuel cell of the type shown in FIG. 2;

FIG. 6 shows a partial view of one non-limiting weave pattern for the wattled spacer material; and

FIG. 7 shows a partial view of another non-limiting weave pattern for the wattled spacer material.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

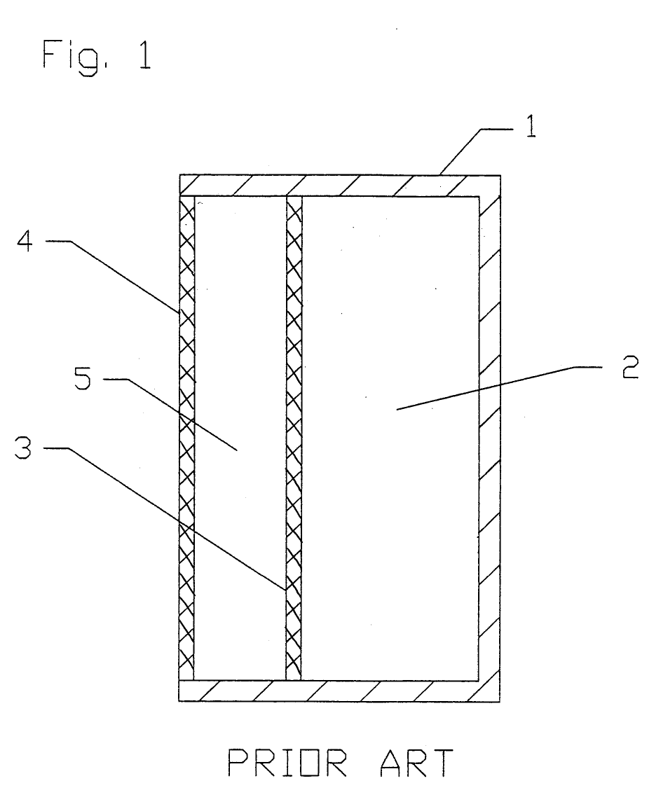

As illustrated in FIG. 1, a conventional DLFC utilizes a case or container body 1 which contains therein a fuel chamber 2 and an electrolyte chamber 5. The case 1 is typically formed of, e.g., a plastic material. The fuel chamber 2 contains liquid fuel in the form of, e.g., a hydride or borohydride fuel. The electrolyte chamber contains liquid electrolyte in the form of, e.g., an aqueous alkali metal hydroxide. An anode 3 is arranged within the case 1 and separates the two chambers 2 and 5. The anode will usually comprise a porous material that is pervious to gaseous and liquid substances. A cathode 4 is also arranged in the case 1 and, together with the anode 3, defines the electrolyte chamber 5. At the anode 3 an oxidation of the liquid fuel takes place. At the cathode a substance, typically oxygen in the ambient air, is reduced.

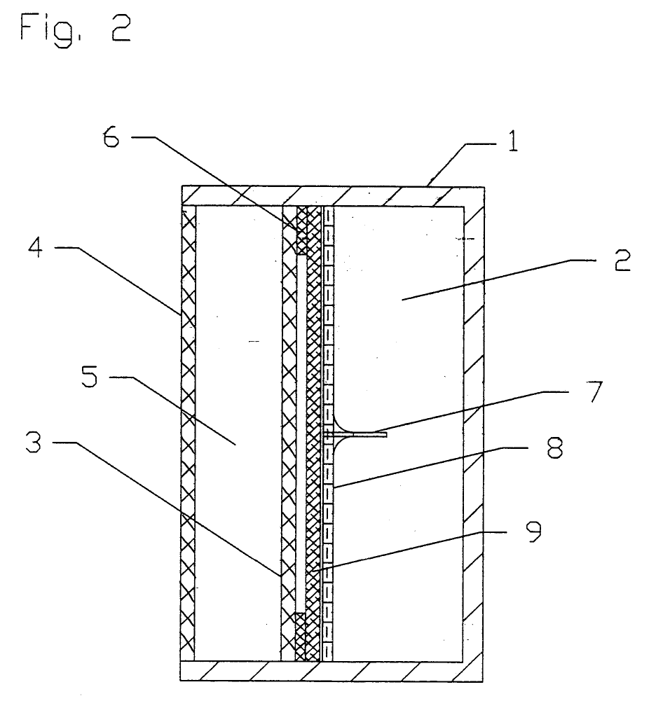

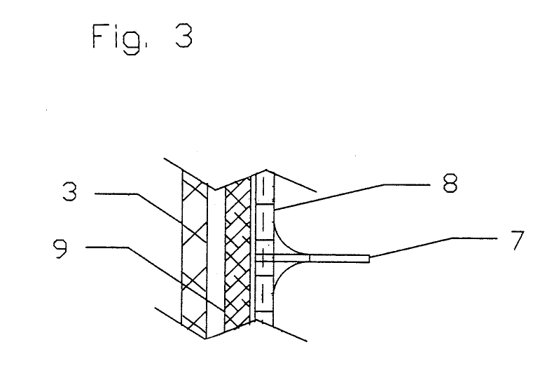

As illustrated in FIG. 2, the DLFC according to the invention differs from the fuel cell illustrated in FIG. 1 at least in that it additionally comprises, arranged inside the case, a frame seal 6, a special membrane 8, a spacer material 9, and a pressure bleeding device having the form of, e.g., a capillary needle 7.

In the DLFC according to the invention, the generated gas, usually hydrogen and usually in the form of micro-bubbles of a size of from about 0.01 to about 2 mm, accumulates into a space between a surface of the anode 3 and the special membrane 8. The bubbles will usually coalesce and/or unite to form a layer of gas which fills essentially all of the volume between anode 3 and the special membrane 8. This, in turn, causes the special membrane 8 to separate the liquid fuel from the anode 3 and to substantially prevent any further contact between the liquid fuel and the anode 3. The space between the anode 3 and membrane 8 can be between approximately 0.1 m and 3.0 mm thick, and is preferably between approximately 0.5 mm and approximately 1.5 mm, and most preferably is approximately 0.5 mm.

Any extra gas which exceeds the volume of the space between the anode 3 and special membrane 8 vents or bleeds out and into the fuel chamber 2 through the capillary needle 7. This bleeding process stops essentially automatically when the pressure in the volume between anode 3 and special membrane 8 equals the pressure in the fuel chamber 2.

The frame seal 6 extends around the perimeter of the anode 3 and is arranged between the anode 3 and the special membrane 8. The frame seal 6 preferably has the form of a thin (non-porous) film and is utilized to prevent fuel from escaping in the area of the borders or outer edges of the anode perimeter. The material of the frame seal 6 will usually be hydrophobic (at least on the surface thereof which faces the fuel chamber) and can be formed from a material such as, e.g., polytetrafluoroethylene, although other hydrophobic materials such as, e.g., olefin polymers like polyethylene and polypropylene may also be used for this purpose. In general, the frame seal will be made or at least include a fluorinated polymer such, e.g., a fluorinated or perfluorinated polyolefin. It is to be noted that the frame seal may also be made of a material that is not hydrophobic as such but has been rendered hydrophobic on the surface thereof by means of, e.g., coating with a hydrophobic material, or any other procedure which affords hydrophobicity. Preferably, the frame seal 6 has a thickness of not more than about 0.1 mm. It will usually have a thickness of at least about 0.02 mm. A thickness of about 0.05 mm is particularly preferred for the frame seal for use in the present invention. The frame seal may be mounted on the anode in many ways, e.g., with application of pressure and/or by using an adhesive. A preferred way of mounting the frame seal comprises insert molding.

The spacer material 9 is arranged between the anode 3 and the special membrane 8. The spacer material 9 also extends to the inside perimeter of the case 1 and, in the perimeter area, is also arranged between the frame seal 6 and the special membrane 8. The purpose of the spacer material 9 is to create a separation distance between the special membrane 8 and the surface of the anode 3. This separation distance forms space or volume for the gas layer. As the gas is generated, it accumulates within and fills this space. The spacer material 9 will permit the essentially free flow of gas across the surface of the anode 3, and will preferably be in the form of net such as, e.g., a wattled net material. The spacer material must be able to withstand the chemical attack by the components of the liquid fuel and will usually be hydrophobic, at least on the outer surfaces thereof. In other words, the spacer material may also be a hydrophilic material which has been made hydrophobic on the other surfaces thereof by any process suitable for this purpose such as e.g., coating with a hydrophobic material. Preferred spacer materials for use in the present invention include organic polymers such as, e.g., olefin homopolymers and olefin copolymers. Specific examples thereof include materials which may also be used for the frame seal such as, e.g., polyethylene, polypropylene, polytetrafluoroethylene, and the like. The spacer material will usually have a thickness of not more than about 3 mm, more commonly a thickness of not more than about 1.5 mm. The spacer material will usually have a thickness of at least about 0.1 mm, preferably at least about 0.5 mm. In a preferred embodiment of the present invention, the spacer material has a thickness of about 0.5 mm. In this regard, it is to be noted that the exemplary and preferred dimensions of the various elements of the DLFC described herein apply particularly to fuel cells for portable devices, e.g., for fuel cells which have dimensions of an order of magnitude which is suitable for portable devices (e.g., labtops, cell phones etc.). Examples of corresponding dimensions are given in the Examples below. For fuel cells which are considerably smaller or larger than those which are suitable for portable devices, the preferred dimensions given herein may not always afford the desired result to the fullest possible extent. One of ordinary skill in the art will, however, be able to readily ascertain the most suitable dimensions for any given size of fuel cell.

As explained above, the special membrane 8 separates the gas layer which has formed at the anode surface from liquid fuel in the fuel chamber. The special membrane is made of a material which can withstand the chemical attack by the components of the liquid fuel and will not catalyze a decomposition of the fuel or a component thereof to any appreciable extent. This material will usually be hydrophilic, at least on the outer surface(s) thereof. Accordingly, the material may be a hydrophobic material which has been rendered hydrophilic on the outer surface thereof by any suitable process, such as coating, surface treatment (e.g., oxidation) and the like. Preferred examples of suitable materials for the special membrane include metals, as such or in the form of alloys. Particularly preferred materials include corrosion-resistant metals and alloys such as nickel, steel, in particular, stainless steel, etc. The hydrophilic material will preferably be present in the form of a foam, a mesh and the like. By way of non-limiting example, the special membrane 8 may be or at least include a stainless steel micromesh with cells of a size of up to about 0.5 mm, e.g., up to about 0.1 mm, or up to about 0.06 mm. A preferred mesh cell size is from about 0.05 mm to about 0.06 mm, a size of about 0.05 mm being particularly preferred. The membrane (mesh) 8 will often have a thickness which does not substantially exceed about 0.3 mm. On the other hand, the thickness of the membrane will usually not be much smaller than about 0.03 mm.

The capillary needle is secured to the special membrane 8 and can be arranged at a convenient position thereon such as, e.g., centrally located (and, preferably, substantially perpendicular to the membrane). As explained above, the purpose of the needle 7 is to balance the pressure between gas layer and liquid fuel in the fuel chamber. The balance pressure range will usually be from about 1 atm to about 1.5 atm (absolute). The needle is made of a material which can withstand the chemical attack by the components of the liquid fuel and does not catalyze a decomposition thereof to any appreciable extent. This material will usually be selected from the materials which are suitable for making the special membrane 8, but may also be made of other materials, e.g., polymeric materials. Non-limiting examples of polymeric materials include polyolefins such as polytetrafluoroethylene and polypropylene. Preferably, the needle 7 is a stainless steel needle. While a suitable length of the needle may vary over a wide range (depending, in part on the dimensions of the spacer, the membrane, etc.) the needle will often have a length of up to about 20 mm, or even longer. The inner diameter of the needle will usually not exceed about 2 mm, preferably not exceed about 1 mm, or not exceed about 0.5 mm. The needle may be attached to the membrane 8 by any suitable method, e.g., by using a thermoadhesive, welding and mechanical attachment (the latter being a preferred method).

### EXAMPLE 1

A conventional DLFC of the type shown in FIG. 1 with the following parameters was employed for testing:
Area of anode and cathode=each 45 cm² (62 mm×73 mm);
Thickness or width of electrolyte chamber=4 mm;
Volume of electrolyte in the electrolyte chamber=18 cm³;
Thickness or width of fuel chamber=20 mm; and
Volume of fuel in the fuel chamber=90 cm³.

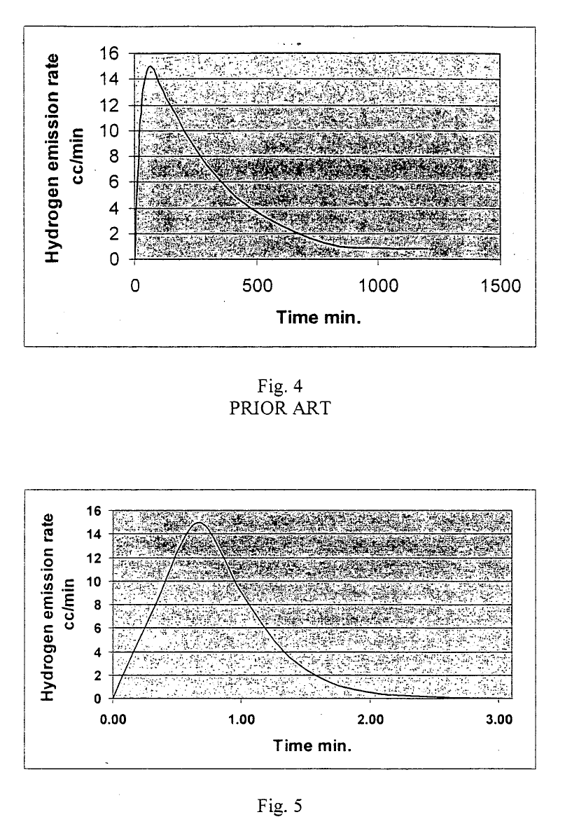

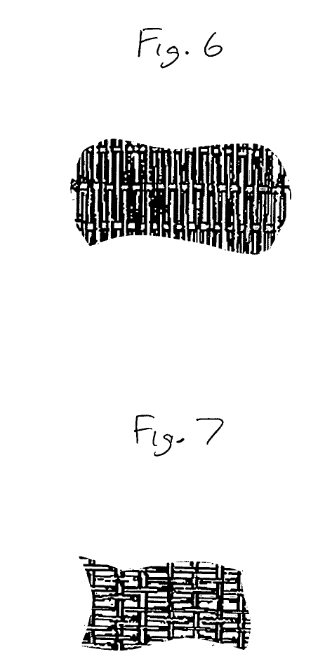

The DLFC was filled with a borohydride fuel and tested under the following conditions:
Full time of test=20 hours;
Unloading regime=open circuit.
   In this test, the maximum gas productivity was 15 cm³/min. As can be seen from FIG. 4, the generation of hydrogen begins to decrease after about 60 minutes, but continues over the full 20 hours of the test.

### EXAMPLE 2

A DLFC according to the present invention of the type shown in FIG. 2 with the following parameters was employed for testing:
Area of anode and cathode=each 45 cm² (62 mm×73 mm);
Thickness or width of electrolyte chamber=4 mm;
Volume of electrolyte in the electrolyte chamber=18 cm³;
Thickness or width of fuel chamber=20 mm; Volume of fuel in the fuel chamber=90 cm³;
Thin film Teflon frame-seal thickness=50 μm;
Stainless steel capillary needle length=7 mm, Inside Diameter=320 μm;
Stainless steel micromesh special membrane with cells=53 μm; and
Polypropylene wattled net spacer material with cells of 2 mm×3 mm and with a thickness=1 mm.

The DLFC was filled with a borohydride fuel and tested under the following conditions:
Full time of test=20 hours;
Unloading regime=open circuit.
   In this test, the time until the space between the anode and the special membrane was filled was 45 seconds. As can be seen from FIG. 5, the generation of hydrogen began to decrease after about 45 seconds, and stopped after about 3 minutes, i.e., the fuel decomposition stopped after about 3 minutes.

As used herein, a “hydrophilic” material is a material that has an affinity for water. The term includes materials which can be wetted, have a high surface tension value and have a tendency to form hydrogen-bonds with water. It also includes materials which have high water vapor permeability.

As used herein, a “hydrophobic” material is a material which repels water. The term includes materials which allow for the passage of gas therethrough but which substantially prevent the flow therethrough of water and similar protic and/or polar liquids.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A direct liquid fuel cell for use with a liquid fuel that is prone to undergo decomposition with generation of a gas, the fuel cell comprising:
a cathode;
an anode;
an electrolyte chamber arranged between the cathode and the anode;
a fuel chamber arranged on a side of the anode which is opposite to a side which faces the electrolyte chamber; and
a membrane arranged on a side of the anode which faces the fuel chamber,
wherein the membrane is structured and arranged to allow gas which is formed on or in the vicinity of a surface of the anode which faces the fuel chamber to accumulate adjacent the anode at least to a point where the accumulated gas substantially prevents a direct contact between the anode and the liquid fuel when liquid fuel is present in the fuel chamber.

2. The fuel cell of claim 1, wherein the gas comprises hydrogen.

3. The fuel cell of claim 1, wherein the fuel comprises at least one of a metal hydride compound and a metal borohydride compound.

4. The fuel cell of claim 1, wherein the membrane comprises a single layer of material.

5. The fuel cell of claim 1, wherein the membrane comprises a layer of hydrophilic material.

6. The fuel cell of claim 1, wherein the membrane comprises a hydrophilic material.

7. The fuel cell of claim 6, wherein the hydrophilic material comprises at least one of a metal and a metal alloy.

8. The fuel cell of claim 7, wherein the hydrophilic material comprises stainless steel.

9. The fuel cell of claim 1, wherein the membrane comprises a mesh.

10. The fuel cell of claim 6, wherein the membrane comprises a stainless steel micromesh.

11. The fuel cell of claim 10, wherein the micromesh comprises cells having a size of up to about 0.5 mm.

12. The fuel cell of claim 11, wherein the cells have a size of from about 0.05 mm to about 0.06 mm.

13. The fuel cell of claim 9, wherein the mesh has a thickness of from about 0.03 mm to about 0.3 mm.

14. The fuel cell of claim 1, wherein the fuel cell further comprises a spacer material which is arranged between the membrane and the anode.

15. The fuel cell of claim 14, wherein the spacer material has a thickness of up to about 3 mm.

16. The fuel cell of claim 14, wherein the spacer material has a thickness of at least about 0.1 mm.

17. The fuel cell of claim 14, wherein the spacer material has a thickness of up to about 1.5 mm.

18. The fuel cell of claim 17, wherein the spacer material has a thickness of at least about 0.5 mm.

19. The fuel cell of claim 14, wherein the spacer material comprises a single layer of material.

20. The fuel cell of claim 14, wherein the spacer material comprises a layer of hydrophobic material.

21. The fuel cell of claim 14, wherein the spacer material comprises a hydrophobic material.

22. The fuel cell of claim 21, wherein the hydrophobic material comprises a polymeric material.

23. The fuel cell of claim 22, wherein the hydrophobic material comprises at least one of an olefin homopolymer and an olefin copolymer.

24. The fuel cell of claim 23, wherein the hydrophobic material comprises at least one of polyethylene, polypropylene and polytetrafluoroethylene.

25. The fuel cell of claim 14, wherein the spacer material comprises a net.

26. The fuel cell of claim 25, wherein the net comprises a wattled net.

27. The fuel cell of claim 25, wherein the net comprises openings of from about 1 mm to about 50 mm.

28. The fuel cell of claim 1, wherein the fuel cell further comprises a frame seal which is arranged on a surface of the anode which faces the membrane.

29. The fuel cell of claim 28, wherein the frame seal comprises a single layer of material.

30. The fuel cell of claim 28, wherein the frame seal comprises a layer of hydrophobic material.

31. The fuel cell of claim 28, wherein the frame seal comprises a hydrophobic material.

32. The fuel cell of claim 31, wherein the hydrophobic material comprises an olefinic polymer.

33. The fuel cell of claim 32, wherein the olefinic polymer comprises a fluorinated polymer.

34. The fuel cell of claim 33, wherein the hydrophobic material comprises polytetrafluoroethylene.

35. The fuel cell of claim 28, wherein the frame seal has a thickness of up to about 0.1 mm.

36. The fuel cell of claim 35, wherein the frame seal has a thickness of from about 0.02 mm to about 0.05 mm.

37. The fuel cell of claim 1, wherein the fuel cell further comprises a pressure relief device which is arranged to allow the gas to escape from a space between the anode and the membrane.

38. The fuel cell of claim 37, wherein the pressure relief device is arranged to allow the gas to escape into the fuel chamber.

39. The fuel cell of claim 37, wherein the pressure relief device comprises a small diameter tube.

40. The fuel cell of claim 39, wherein the tube has an inner diameter of up to about 2 mm.

41. The fuel cell of claim 40, wherein the inner diameter is up to about 1 mm.

42. The fuel cell of claim 39, wherein the small diameter tube has a length of up to about 20 mm.

43. The fuel cell of claim 42, wherein the length is up to about 10 mm.

44. The fuel cell of claim 39, wherein the small diameter tube comprises a capillary needle.

45. The fuel cell of claim 39 wherein the small diameter tube comprises a stainless steel tube.

46. The fuel cell of claim 39, wherein the small diameter tube comprises at least one of a length of about 7 mm and an inside diameter of about 1 mm.

47. The fuel cell of claim 1, wherein the membrane and the anode are arranged substantially in parallel.

48. The fuel cell of claim 14, wherein the membrane and the spacer material form an integral structure.

49. A direct liquid fuel cell for use with a liquid fuel that is prone to undergo decomposition with generation of a gas, the fuel cell comprising:
a cathode;
an anode;
an electrolyte chamber arranged between the cathode and the anode;
a fuel chamber arranged on a side of the anode which is opposite to a side which faces the electrolyte chamber;
a membrane arranged on a side of the anode which faces the fuel chamber; and
a spacer material having a thickness of at least about 0.1 mm and being arranged between the anode and the membrane,
wherein the membrane and the spacer material are structured and arranged to allow gas which is formed on or in the vicinity of a surface of the anode which faces the fuel chamber to accumulate adjacent the anode at least to a point where the gas substantially prevents a direct contact between the anode and the liquid fuel when liquid fuel is present in the fuel chamber.

50. The fuel cell of claim 49, wherein the membrane comprises a hydrophilic material.

51. The fuel cell of claim 50, wherein the hydrophilic material comprises at least one of a metal and a metal alloy.

52. The fuel cell of claim 51, wherein the membrane comprises a mesh.

53. The fuel cell of claim 49, wherein the membrane comprises a stainless steel micromesh.

54. The fuel cell of claim 53, wherein the micromesh comprises cells having a size of up to about 0.5 mm.

55. The fuel cell of claim 53, wherein the cells have a size of up to about 0.06 mm.

56. The fuel cell of claim 49, wherein the spacer material comprises a hydrophobic material.

57. The fuel cell of claim 56, wherein the hydrophobic material comprises at least one of an olefin homopolymer and an olefin copolymer.

58. The fuel cell of claim 56, wherein the hydrophobic material comprises polypropylene.

59. The fuel cell of claim 56, wherein the spacer material comprises a wattled net.

60. The fuel cell of claim 59, wherein the wattled net comprises cells having dimensions of from about 2 mm to about 3 mm.

61. The fuel cell of claim 49, wherein the spacer material has a thickness of up to about 3 mm.

62. The fuel cell of claim 56, wherein the spacer material has a thickness of about 0.5 mm.

63. The fuel cell of claim 49, wherein the fuel cell further comprises a frame seal which is arranged on a surface of the anode which faces the membrane.

64. The fuel cell of claim 63, wherein the frame seal comprises a hydrophobic material.

65. The fuel cell of claim 64, wherein the hydrophobic material comprises a fluorinated polymer.

66. The fuel cell of claim 64, wherein the hydrophobic material comprises polytetrafluoroethylene.

67. The fuel cell of claim 66, wherein the frame seal has a thickness of up to about 0.1 mm.

68. The fuel cell of claim 49, wherein the fuel cell further comprises a pressure relief device which is arranged to allow the gas to escape from a space between the anode and the membrane.

69. The fuel cell of claim 68, wherein the pressure relief device is arranged to allow the gas to escape into the fuel chamber.

70. The fuel cell of claim 69, wherein the pressure relief device comprises a tube having an inner diameter of up to about 1 mm.

71. The fuel cell of claim 70, wherein the tube has a length of up to about 20 mm.

72. The fuel cell of claim 68, wherein the pressure relief device comprises a capillary needle.

73. The fuel cell of claim 72 wherein the capillary needle comprises a stainless steel tube.

74. A direct liquid fuel cell for use with a liquid fuel that is prone to undergo decomposition with generation of a gas, the fuel cell comprising:
a cathode;
an anode;
an electrolyte chamber arranged between the cathode and the anode;
a fuel chamber arranged on a side of the anode which is opposite to a side which faces the electrolyte chamber;
a membrane arranged on a side of the anode which faces the fuel chamber;
a spacer material being arranged between the anode and the membrane; and
a pressure relief device for allowing gas which is present between the anode and the membrane to escape into the fuel chamber,
wherein the membrane, the spacer material and the pressure relief device are structured and arranged to allow gas which is formed on or in the vicinity of a surface of the anode which faces the fuel chamber to accumulate adjacent the anode at least to a point where the gas substantially prevents a direct contact between the anode and the liquid fuel when liquid fuel is present in the fuel chamber.

75. The fuel cell of claim 74, wherein the membrane comprises a hydrophilic material.

76. The fuel cell of claim 75, wherein the hydrophilic material comprises at least one of a metal and a metal alloy.

77. The fuel cell of claim 75, wherein the membrane comprises a micromesh.

78. The fuel cell of claim 77, wherein the micromesh comprises stainless steel.

79. The fuel cell of claim 77, wherein the micromesh comprises cells having a size of up to about 0.5 mm.

80. The fuel cell of claim 74, wherein the spacer material comprises a hydrophobic material.

81. The fuel cell of claim 81, wherein the hydrophobic material comprises a polymeric material.

82. The fuel cell of claim 81, wherein the polymeric material comprises polypropylene.

83. The fuel cell of claim 80, wherein the spacer material comprises a net.

84. The fuel cell of claim 83, wherein the net comprises openings of up to about 50 mm.

85. The fuel cell of claim 81, wherein the spacer material has a thickness of up to about 1.5 mm.

86. The fuel cell of claim 80, wherein the spacer material has a thickness of at least about 0.5 mm.

87. The fuel cell of claim 74, wherein the fuel cell further comprises a frame seal which is arranged on a surface of the anode which faces the membrane.

88. The fuel cell of claim 87, wherein the frame seal comprises a hydrophobic material.

89. The fuel cell of claim 88, wherein the hydrophobic material comprises polytetrafluoroethylene.

90. The fuel cell of claim 88, wherein the frame seal has a thickness of up to about 0.05 mm.

91. A method of reducing or substantially preventing fuel decomposition at an anode of a direct liquid fuel cell which uses a fuel that generates a gas when undergoing said decomposition, wherein the method comprises forming a gas during an initial decomposition of the fuel in the fuel cell, wherein the gas restricts or substantially prevents contact between the fuel and the anode.

92. The method of claim 91, wherein the forming comprises substantially preventing, with the gas, the fuel from contacting the anode.

93. The method of claim 91, wherein the forming comprises forming a substantially continuous layer of gas across substantially an entire surface of the anode that faces a fuel chamber of the fuel cell.

94. The method of claim 91, wherein the fuel comprises at least one of a hydride compound and a borohydride compound.

95. The method of claim 94, wherein the fuel comprises an alkali metal borohydride.

96. The method of claim 95, wherein the fuel comprises sodium borohydride dissolved or suspended in a liquid carrier.

97. The method of claim 91, wherein the gas comprises hydrogen.

98. The method of claim 91, further comprising restricting or substantially preventing a flow of the gas away from the anode.

99. The method of claim 91, further comprising placing the fuel cell under substantially no load so as to cause fuel decomposition.

100. The method of claim 99, further comprising substantially stopping initial fuel decomposition within not more than about 5 minutes.

101. The method of claim 99, further comprising substantially stopping initial fuel decomposition within not more than about 3 minutes.

102. The method of claim 91, further comprising limiting or substantially preventing, with a structure, an ability of the gas to flow away from the anode on a side of the anode which faces a fuel chamber of the fuel cell.

103. The method of claim 102, wherein the structure comprises a membrane and a spacer material, whereby a space is defined between the anode and the membrane, which space is capable of being substantially filled with the gas.

104. A method of preventing or reducing fuel decomposition in the fuel cell of claim 1, wherein the method comprises:
generating electrical energy with the fuel cell;
substantially preventing the fuel cell from further generating electrical energy; and
facilitating, with the membrane, an accumulation adjacent the anode of the gas generated at the anode at least to a point where the accumulated gas limits or substantially prevents contact between the anode and the fuel.

105. A method of preventing or reducing fuel decomposition in the fuel cell of claim 1, wherein the method comprises:
generating electrical energy with the fuel cell;
substantially preventing the fuel cell from further generating electrical energy; and
causing gas generated at the anode to accumulate adjacent the anode at least to a point where the accumulated gas substantially prevents a contact between the anode and the fuel.
